(19) United States
(12) Patent Application Publication
(10) Pub. No.: US 2022/0246939 A1
(43) Pub. Date: Aug. 4, 2022

(54) ELECTRODE FOR LITHIUM ION SECONDARY BATTERY AND METHOD OF MANUFACTURING THE SAME

(71) Applicant: HONDA MOTOR CO., LTD., Tokyo (JP)

(72) Inventors: Takashi Nakagawa, Saitama (JP); Ken Baba, Saitama (JP); Takeshi Fujino, Saitama (JP)

(21) Appl. No.: 17/648,680

(22) Filed: Jan. 24, 2022

(30) Foreign Application Priority Data
Jan. 28, 2021 (JP) 2021-011628

(51) Int. Cl. H01M 4/62; H01M 4/36; H01M 4/04

(52) U.S. Cl. CPC H01M 4/622; H01M 4/364; H01M 2004/027; H01M 4/0416; H01M 4/043

(57) ABSTRACT

To provide an electrode for a lithium ion secondary battery in which the binding strength of an electrode active material can be increased without increasing the amount of a binder, and a desirable energy density of the lithium ion secondary battery can be achieved, and a method of manufacturing the same. An electrode for a lithium ion secondary battery includes an electrode active material, a dendritic polymer, and a binder. The dendritic polymer is chemically bonded to a surface of the electrode active material. The dendritic polymer and the binder are chemically bonded to each other.

This application is based on and claims the benefit of priority from Japanese Patent Application No. 2021-011628, filed on 28 Jan. 2021, the content of which is incorporated herein by reference.

### BACKGROUND OF THE INVENTION

### Field of the Invention

The present invention relates to an electrode for a lithium ion secondary battery and a method of manufacturing the same.

### Related Art

Conventionally, lithium ion secondary batteries have been widely used. An electrode for a lithium ion secondary battery is formed by binding a powder of an electrode active material to a current collector using a binder. It is known that an electrode for a lithium ion secondary battery expands and contracts during charging and discharging, resulting in capacity degradation of the lithium ion secondary battery. Accordingly, a technology is known to suppress capacity degradation of a lithium ion secondary battery during charging and discharging by adjusting the type and content of a binder (for example, see Patent Document 1).
Patent Document 1: Japanese Unexamined Patent Application, Publication No. 2000-285966

### SUMMARY OF THE INVENTION

In the case of binding an electrode active material only with a binder as disclosed in Cited Document 1, the binding strength of the binder decreases with charging and discharging. If the amount of the binder is increased, the binding strength can be strengthened and the expansion and contraction of the electrode can be suppressed. However, the wettability of the electrolytic solution decreases, resulting in lower electrode performance, and impregnability of the electrolytic solution decreases, resulting in longer aging time at the time of manufacturing the electrode. In addition, the electrode swells during impregnation with the electrolytic solution, which reduces the density of the electrode active material, thereby lowering the energy density of the lithium ion secondary battery.

In response to the above issues, it is an object of the present invention to provide an electrode for a lithium ion secondary battery in which the binding strength of an electrode active material can be increased without increasing the amount of a binder, and a desirable energy density of the lithium ion secondary battery can be achieved, and a method of manufacturing the same.

(1) A first aspect of the present invention relates to an electrode for a lithium ion secondary battery. The electrode includes an electrode active material, a dendritic polymer, and a binder. The dendritic polymer is chemically bonded to a surface of the electrode active material. The dendritic polymer and the binder are chemically bonded to each other.

According to the invention of the first aspect, the binding strength of the electrode active material can be increased without increasing the amount of the binder, and the electrode for a lithium ion secondary battery can be provided with a desirable energy density of the lithium ion secondary battery.

(2) In a second aspect of the present invention according to the first aspect, the electrode active material is a negative electrode active material. A density of a negative electrode material mixture layer including the electrode active material, the dendritic polymer, and the binder after impregnation with an electrolytic solution is 95% or more of a density of the negative electrode material mixture layer before impregnation with the electrolytic solution.

According to the invention of the second aspect, a decrease in density of the electrode active material of the electrode due to impregnation with the electrolytic solution can be prevented. In addition, it is possible to minimize the securing of the space in the battery cell in consideration of variation in thickness and width of electrode, which was necessary in the design of lithium ion secondary batteries. Therefore, the volumetric energy density of the lithium ion secondary battery can be improved.

(3) In a third aspect of the present invention according to the first or second aspect, the electrode active material is a negative electrode active material. An amount of the dendritic polymer chemically bonded to the surface of the negative electrode active material is 0.1 to 1.0 part by mass with respect to 100 parts by mass of the negative electrode active material.

According to the invention of the third aspect, the electrode for a lithium ion secondary battery according to the second aspect can be obtained.

(4) A fourth aspect of the present invention relates to a method of manufacturing an electrode for a lithium ion secondary battery. The method includes an electrode material mixture layer forming step of forming an electrode material mixture layer including an electrode active material, a dendritic polymer, and a binder on a current collector; a pressing step of pressurizing at a first temperature the current collector on which the electrode material mixture layer is formed to form an electrode; and a vacuum drying step of vacuum drying at a second temperature the electrode formed by the pressing step.

According to the invention of the fourth aspect, the binding strength of the electrode active material can be increased without increasing the amount of the binder, and the electrode for a lithium ion secondary battery can be manufactured with a desirable energy density of the lithium ion secondary battery.

(5) In a fifth aspect of the present invention according to the fourth aspect, a density of the electrode material mixture layer after impregnation with an electrolytic solution is adjusted to 95% or more of a density of the electrode material mixture layer before impregnation with the electrolytic solution by adjusting the first temperature and the second temperature.

According to the invention of the fifth aspect, the electrode for a lithium ion secondary battery according to the second aspect can be manufactured.

### DETAILED DESCRIPTION OF THE INVENTION

An embodiment of the present invention will now be described. The present invention is not limited to the following embodiment.

### <Lithium Ion Secondary Battery>

A lithium ion secondary battery according to the present embodiment includes a positive electrode and a negative electrode as electrodes, a separator electrically insulating the positive electrode and the negative electrode, an electrolytic solution, and an outer packaging body housing these. In the interior of the outer packaging body, the positive electrode and the negative electrode face each other with the separator provided therebetween, and at least a part of the separator is immersed in the electrolytic solution.

### [Electrode for Lithium Ion Secondary Battery]

The positive electrode includes a positive electrode material mixture layer as an electrode material mixture layer, which is formed on a positive electrode current collector, and the negative electrode includes a negative electrode material mixture layer as an electrode material mixture layer, which is formed on a negative electrode current collector. An electrode for a lithium ion secondary battery according to the present embodiment may be applied to the positive electrode or to the negative electrode. In particular, it is preferable to apply the electrode for a lithium ion secondary battery according to this embodiment to the negative electrode, in which the volume change due to the occlusion and release of lithium ions during charging and discharging tends to be large.

### (Electrode Material Mixture Layer)

The positive electrode material mixture layer includes at least a positive electrode active material as an electrode active material, a dendritic polymer, and a binder. Similarly, the negative electrode material mixture layer includes at least a negative electrode active material as an electrode active material, a dendritic polymer, and a binder. In addition to these, the electrode material mixture layer may further include a conductivity aid. For each electrode, numerous particles of the corresponding electrode active material are aggregated and disposed in the electrode material mixture layer. The dendritic polymer is chemically bonded to the surfaces of particles of the electrode active material. The dendritic polymer and the binder are chemically bonded to each other. This allows the binding strength between particles of the electrode active material to be increased without increasing the amount of the binder, the density of the electrode active material to be maintained, and the expansion and contraction of the electrode during charging and discharging to be reduced.

The density of the electrode material mixture layer after impregnation with the electrolytic solution is preferably 95% or more of the density of the electrode material mixture layer before impregnation with the electrolytic solution. This prevents a decrease in the density of the electrode active material of the electrode due to impregnation with the electrolytic solution. In addition, it is possible to minimize the space in the battery cell in consideration of variation in thickness and width of electrode, which was necessary in the design of lithium ion secondary batteries. Therefore, the volumetric energy density of the lithium ion secondary battery can be improved. The density of the negative electrode material mixture layer after impregnation with the electrolytic solution is preferably 1.4 g/cm³ or more from the viewpoint described above.

### (Electrode Active Material)

Examples of the negative electrode active material include carbon powder (amorphous carbon), silica (SiOₓ), titanium complex oxides (Li₄Ti₅O₇, TiO₂, Nb₂TiO₇), tin complex oxides, lithium alloys, and metallic lithium, and one or more of them can be used. As the carbon powder, one or more of soft carbon (easily graphitizable carbon), hard carbon (non-graphitizable carbon), and graphite can be used.

Examples of the positive electrode active material include lithium complex oxides (LiNiₓCo_{y}Mn_{z}O₂ (x+y+z=1), LiNiₓCo_{y}Al_{z}O₂ (x+y+z=1)), and lithium iron phosphate (LiFePO₄ (LFP)). One of the above may be used, or two or more of the above may be used in combination.

It is preferable that the electrode active material at least partially includes a hydroxyl group or a carboxy group. This allows the dendritic polymer to be chemically bonded to the surface of the electrode active material.

### (Dendritic Polymer)

Dendritic polymers are a general term for polymers with a branched structure. Examples of the dendritic polymer include dendrons, dendrimers, and hyperbranched polymers.

Dendrons can be synthesized using usual methods, or commercial products can be used. Such commercial products can be obtained, for example, from Sigma-Aldrich. Specific examples of dendrons manufactured by Sigma-Aldrich include Polyester-8-hydroxyl-1-acetylene bis-MPA dendron, generation 3 (Catalog No. 686646), Polyester-16-hydroxyl-1-acetylene bis-MPA dendron, generation 4 (Catalog No. 686638), Polyester-32-hydroxyl-1-acetylene bis-MPA dendron, generation 5 (Catalog No. 686611), Polyester-8-hydroxyl-1-carboxyl bis-MPA dendron, generation 3 (Catalog No. 686670), Polyester-16-hydroxyl-1-carboxyl bis-MPA dendron, generation 4 (Catalog No. 686662), and Polyester-32-hydroxyl-1-carboxyl bis-MPA dendron, generation 5 (Catalog No. 686654).

Dendrimers can be synthesized using usual methods, or commercial products can be obtained from Sigma-Aldrich. For example, dendrimers with terminal amino groups are polyamidoamine dendrimer, ethylenediamine core, generation 0.0 (Catalog No. 412368), polyamidoamine dendrimer, ethylenediamine core, generation 1.0 (Catalog No. 412368), polyamidoamine dendrimer, ethylenediamine core, generation 2.0 (Catalog No. 412406), polyamidoamine dendrimer, ethylenediamine core, generation 3.0 (Catalog No. 412422), polyamidoamine dendrimer, ethylenediamine core, generation 4.0 (Catalog No. 412446), polyamidoamine dendrimer, ethylenediamine core, generation 5.0 (Catalog No. 536709), polyamidoamine dendrimer, ethylenediamine core, generation 6.0 (Catalog No. 536717), and polyamidoamine dendrimer, ethylenediamine core, generation 7.0 (Catalog No. 536725). In addition to dendrimers with terminal amino groups, dendrimers with terminal hydroxy groups, carboxy groups, or trialkoxysilyl groups can be obtained.

Hyperbranched polymers can be synthesized using usual methods, or commercial products can be obtained from Sigma-Aldrich. Examples thereof include Hyperbranched bis-MPA polyester-16-hydroxyl, generation 2 (Catalog No. 686603), Hyperbranched bis-MPA polyester-32-hydroxyl, generation 3 (Catalog No. 686581), and Hyperbranched bis-MPA polyester-64-hydroxyl, generation 4 (Catalog No. 686573).

The amount of the dendritic polymer chemically bonded to the surface of the electrode active material is preferably 0.1 to 1.0 part by mass with respect to 100 parts by mass of the electrode active material. The amount of the dendritic polymer is more preferably 0.25 to 1.0 part by mass. This can suppress the swelling of the electrode without increasing the amount of the binder in the electrode. Therefore, the energy density of the electrode and lithium ion secondary battery cell can be improved.

It is preferable that the dendritic polymer has a branched structure in a certain range and includes terminal functional groups capable of a cross-linking reaction. This maintains the bonding strength between particles of the electrode active material, and the branching structure of moderate molecular weight does not inhibit the movement of lithium ions. Thus, even if the electrode body has a high density in the cell, a low-resistance cell can be produced. Preferred examples of the dendritic polymer are given below. The following dendritic polymers are electrochemically stable and are difficult to decompose in a battery.

The dendritic polymer preferably has four or more molecular terminals in one molecule. In addition, the dendritic polymer preferably has specific functional groups as described below. When the dendritic polymer has molecular terminals in the above range and the molecular terminals have specific functional groups, the contact probability of the specific functional groups to the electrode active material increases. Therefore, the amount of the dendritic polymer chemically bonded to the electrode active material is in an appropriate range, and the dendritic polymer can be strongly chemically bonded to the electrode active material to cover the surface of the electrode active material. It is more preferable that the dendritic polymer has 4 or more and 64 or less molecular terminals. It is further preferable that the dendritic polymer has eight or more hydroxyl groups and at least one carboxy group as the specific functional groups. As a result, the formation of an ether bond is formed, for example, by dehydration condensation of the dendritic polymer and the electrode active material. The terminal active groups of the dendritic polymers exemplified above can be converted into the above specified functional groups using any reaction.

The number average molecular weight of the dendritic polymer is preferably 300 or more and 100000 or less, more preferably 800 or more and 10000 or less. If the number average molecular weight is within the above range, the lithium ion occlusion surface on the particle surface of the electrode active material can be sufficiently covered, and direct contact of the electrolytic solution with the lithium ion occlusion surface can be suppressed, thereby improving the durability of the electrode and the electrolytic solution. In addition, since the dendritic polymer covers the electrode material mixture layer to a degree that does not hinder the movement of lithium ions, good lithium ion conductivity of the electrode material mixture layer can be obtained.

### (Binder)

The binder forms a chemical bond with the dendritic polymer. The binder forms an ether bond, for example, by a dehydration condensation reaction with the dendritic polymer. The binder preferably includes at least one of a hydroxyl group, a carboxyl group, a sulfonic acid group, a sulfinic acid group, a phosphoric acid group, or a phosphonic acid group.

Examples of the binder include cellulosic polymers, fluorinated resins, vinyl acetate copolymers, and rubbers. Specifically, as a binder when a solvent-based dispersion medium is used, polyvinylidene fluoride (PVDF), polyimide (PI), polyvinylidene chloride (PVDC), polyethylene oxide (PEO), or the like can be used. As a binder when an aqueous dispersion medium is used, styrene butadiene rubber (SBR), acrylic acid-modified SBR resin (SBR-based latex), carboxymethyl cellulose (CMC), polyvinyl alcohol (PVA), polytetrafluoroethylene (PTFE), hydroxypropylmethylcellulose (HPMC), fluorinated ethylene propylene copolymer (FEP), or the like can be used. One of the above may be used, or two or more of the above may be used in combination.

### (Conductivity Aid)

Examples of the conductivity aid include carbon black such as acetylene black (AB) and Ketjen black (KB), carbon material such as graphite powder, and conductive metal powder such as nickel powder. One of the above may be used, or two or more of the above may be used in combination.

### (Current Collector)

As the materials of the positive electrode current collector and the negative electrode current collector, a foil or a plate of copper, aluminum, nickel, titanium, and stainless steel, a carbon sheet, a carbon nanotube sheet, or the like can be used. One of the above may be used or, if necessary, a metal clad foil including two or more materials may be used. The thicknesses of the positive electrode current collector and the negative electrode current collector are not limited, and can be, for example, in the range of 5 to 100 prm. It is preferable that the thicknesses of the positive electrode current collector and the negative electrode current collector are in the range of 7 to 20 μm from the viewpoint of improving the structure and performance.

### [Separator]

The separator is not limited, and examples thereof include porous resin sheets (e.g., films, nonwoven fabrics) including a resin such as polyethylene (PE), polypropylene (PP), polyester, cellulose, or polyamide.

### [Electrolytic Solution]

As the electrolytic solution, one including a nonaqueous solvent and an electrolyte can be used. The concentration of the electrolyte is preferably in the range of 0.1 to 10 mol/L. An additive containing at least one compound selected from the group consisting of vinylene carbonate, fluoroethylene carbonate, and propane sultone may be added to the electrolytic solution. As a result, by using an electrolytic solution to which a compound that has reductive decomposition properties and tends to form a solid electrolyte interphase (SEI) layer is added, the added compound is preferentially decomposed in the electrolytic solution to form an SEI layer on the negative electrode, and thus the durability of the electrolytic solution can be improved.

### (Non-Aqueous Solvent)

The non-aqueous solvent is not limited, and examples thereof include aprotic solvents such as carbonates, esters, ethers, nitriles, sulfones, and lactones. Specifically, ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, γ-butyrolactone, and the like may be used.

### (Electrolyte)

Examples of the electrolyte contained in the electrolytic solution include LiPF₆, LiBF₄, LiClO₄, LiN(SO₂CF₃), LiN(SO₂C₂F₅)₂, LiCF₃SO₃, LiC₄F₉SO₃, LiC(SO₂CF₆₃)₃, LiF, LiCl, LiI, Li₂S, Li₃N, Li₃R, Li₁₀GeP₂S₁₂ (LGPS), Li₃PS₄, Li₆PS₅Cl, Li₇P₂S₈I, LiₓPO_{y}N_{z} (x=2y+3z−5, LiPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓSiyP_{3-y}O₁₂, Li_{1+x+y}Alₓ(Ti,Ge)₂₋ₓSiyP_{3-y}O₁₂, and Li₄₋₂ₓZnₓGeO₄ (LISTCON). Among them, LiPF₆, LiBF₄, or a mixture thereof is preferably used as the electrolyte.

As the electrolytic solution, in addition to the above, an ionic liquid or an ionic liquid containing a polymer containing an aliphatic chain such as a polyethylene oxide (PEO) copolymer or a polyvinylidene fluoride (PVDF) copolymer can be used. An electrolytic solution containing an ionic liquid can flexibly cover the surface of the electrode active material and contacts with the surface of the electrode active material to form sites where ions move.

### <Method of Manufacturing Electrode for Lithium Ion Secondary Battery>

A method of manufacturing a lithium ion secondary battery according to the present embodiment includes an electrode material mixture layer forming step of forming an electrode material mixture layer including an electrode active material, a dendritic polymer, and a binder on a current collector; a pressing step of pressurizing at a first temperature the current collector on which the electrode material mixture layer is formed to form an electrode; and a vacuum drying step of vacuum drying at a second temperature the electrode formed by the pressing step.

### (Electrode Material Mixture Layer Forming Step)

The electrode material mixture layer forming step may include, for example, an agitation step of agitating a mixture of the electrode active material and the dendritic polymer, a drying under reduced pressure step of drying the mixture under reduced pressure after the agitation step, an electrode paste preparation step of mixing the mixture with the binder and dispersing the resultant mixture in a solvent to prepare an electrode paste after the drying under reduced pressure step, and an electrode paste application step of applying the electrode paste to the current collector to dry the electrode paste. The electrode material mixture layer forming step is not limited to the above, as long as an electrode material mixture layer can be formed on a current collector.

The drying under reduced pressure step is, for example, a step of drying the mixture of the electrode active material and the dendritic polymer under reduced pressure at a predetermined temperature and time to chemically bond the dendritic polymer to the surface of the electrode active material. The temperature during drying under reduced pressure can be 100° C. to 200° C., preferably 120° C. to 150° C. The drying time is preferably 12 hours or more.

### (Pressing Step)

The pressing step is a step of pressurizing at the first temperature the current collector on which the electrode material mixture layer is formed. The first temperature can be, for example, room temperature to 200° C., preferably 120° C. to 160° C. The pressurizing method is not limited, and for example, roll pressing or hot pressing can be used.

### (Vacuum Drying Step)

The vacuum drying step is a step of vacuum drying at the second temperature the electrode that has undergone the pressing step. In this step, chemical bonds are formed between particles of the electrode active material chemically bonded to the dendritic polymers and between the dendritic polymer and the binder. The second temperature can be, for example, 120° C. to 200° C. The second temperature is preferably 120° C. to 160° C. When the second temperature exceeds 200° C., the heat resistance temperature of a binder may be exceeded, and thus the effect of suppressing swelling of an electrode is reduced. When the second temperature is less than 120° C., the production efficiency is reduced because it takes time for water generated by dehydration reaction to be discharged from an electrode material mixture layer having a fine pore structure. The vacuum conditions in the vacuum drying step can be, for example, −98 kPa or less.

By adjusting the first temperature in the pressing step and the second temperature in the vacuum drying step, the density of the electrode material mixture layer after impregnation with the electrolytic solution can be adjusted to 95% t or more of the density of the electrode material mixture layer before impregnation with the electrolytic solution. The first temperature can be adjusted, for example, by a non-contact thermometer attached to a roll press device. The second temperature can be adjusted by a thermometer, such as a thermistor, attached to a vacuum high temperature chamber.

### EXAMPLES

The present invention will be described in more detail based on the following examples. The present invention is not limited to the description of the following examples.

A negative electrode plate according to Example 1 was prepared by the following procedure. First, 0.1 parts by mass of dendron (polyester-32-hydroxyl-1-carboxyl bis-MPA dendron, generation 5) as a dendritic polymer was weighed with respect to 100 parts by weight of graphite as an electrode active material, and they were agitated in an aqueous solution for 1 hour. Subsequently, the mixture was dried under reduced pressure at 150° C. for 16 hours to obtain a negative electrode material with the dendritic polymer bonded to the surface of the electrode active material. It is considered that all dendrons as the above dendritic polymers are chemically bonded to the surface of the electrode active material. Then, carboxymethyl cellulose (CMC) and a conductivity aid were mixed and dispersed using a planetary mixer. Thereafter, the negative electrode material obtained above was mixed into the mixture and was dispersed again using the planetary mixer. Subsequently, a dispersing solvent and styrene-butadiene rubber (SBR) were added to the mixture and dispersed to prepare an electrode paste. This electrode paste was applied to a current collector made of Cu and dried.

The current collector made of Cu to which the electrode paste was applied and dried, was pressurized by roll pressing under room temperature. This was placed in a vacuum drying furnace, heated to a vacuum drying temperature of 120° C., and subjected to a condensation reaction for 12 hours under −98 kPa or lower, and thus the negative electrode plate according to Example 1 was prepared. For the electrodes of other examples and comparative examples, the negative electrode plates of the other examples and comparative examples were each prepared in the same manner as in Example 1, except that the content of the dendritic polymer, the pressing temperature, and the vacuum drying temperature shown in Table 1 were used.

### [Density Retention Rate of Electrode Material Mixture]

The negative electrode plates of the examples and comparative examples were each punched to a size of 16 mmφ to make a test piece. The film thickness of the test piece under room temperature after vacuum drying was measured with a micrometer, the weight of the test piece was measured, and thereby the density (g/cm³) of the test piece was calculated. After that, 10 μL of a mixed solvent of ethylene carbonate (EC):diethyl carbonate (DEC):EMC=3:4:4 (volume ratio) was dropped onto the test piece, and a glass plate was placed on the test piece to prevent the solvent from drying. After 30 minutes, the glass plate was removed and an excess solvent was removed with a Kim Wipe. After confirming that the solvent was removed visually, the film thickness of the test piece was measured with a micrometer, the weight of the test piece was measured, and thereby the density (g/cm³) of the test piece after dropping the solvent was calculated. The rate of the density of the test piece after dropping the solvent to the density of the test piece before dropping the solvent was defined as a density retention rate (%) of an electrode material mixture. The results are shown in Table 1.

### [Manufacture of Lithium Ion Secondary Battery]

Lithium ion secondary batteries were manufactured using the negative electrode plates of the examples and comparative examples.

### (Manufacture of Positive Electrode)

A conductivity aid and polyvinylidene fluoride (PVDF) were mixed and dispersed with a planetary centrifugal mixer. Then, Li₁Ni_{0.6}Co_{0.2}Mn_{0.2}O₂ (NCM622) as a positive electrode active material was mixed into the mixture, and the resultant mixture was mixed using a planetary mixer. Subsequently, N-methyl-N-pyrrolidinone (NMP) was added to the mixture, and thus an electrode paste was prepared. The electrode paste was applied to a current collector made of Al and dried, and then pressurized by roll pressing. This was dried in a vacuum at 120° C. to make a positive electrode plate. The electrode plate was punched to 30 mm×40 mm. The thickness of the positive electrode plate was 70 μm.

A laminate, in which a separator was interposed between the negative electrode and the positive electrode manufactured above, was introduced into a pouch-like container prepared by heat-sealing an aluminum laminate for secondary batteries (manufactured by Dai Nippon Printing Co., Ltd.). Then, an electrolytic solution was injected into each electrode interface to manufacture a lithium ion secondary battery. As the electrolytic solution, a solution obtained by dissolving LiPF₆ at a concentration of 1.2 mol/L in a solvent obtained by mixing ethylene carbonate, ethyl methyl carbonate (EMC), and dimethyl carbonate (DMC) at a volume ratio of 30:30:40 was used. The following tests were conducted using the manufactured lithium ion secondary batteries.

[10s Asst. Initial Resistance Measurement]

The 10s asst. initial resistance of the lithium ion secondary battery of each of the examples and comparative examples was measured by the following method. First, the charge level (state of charge (SOC)) of the lithium ion secondary battery was adjusted to 50%. Then, the lithium ion secondary battery was subjected to pulse discharge at a C rate of 0.5 C for 10 seconds, and the voltage at the time of the completion of the 10 second discharge was measured. The voltage at the time of the completion of the 10 second discharge was plotted with respect to the current at 0.5 C, with the horizontal axis being the current value, and the vertical axis being the voltage. Subsequently, after being left to stand for 5 minutes, the lithium ion secondary battery was subjected to auxiliary charge to reset the SOC to 50%, and further left to stand for 5 minutes. The above operation was performed at C rates of 1.0 C, 1.5 C, 2.0 C, 2.5 C, and 3.0 C, and the voltage at the time of the completion of the 10 second discharge was plotted with respect to the current at each C rate. The slope of the approximate straight line obtained from each plot was defined as the 10s asst. initial cell resistance of the lithium ion secondary battery. The results are shown in Table 1.

TABLE 1

| | | | | Density | |
|---|---|---|---|---|---|
| | | | | retention | |
| | Content of | | Vacuum | rate of | 10s |
| | dendritic | | drying | electrode | asst. |
| | polymer | Pressing | temper- | material | intial |
| | (parts | temperature | ature | mixture | resistance |
| | by mass) | (° C.) | (° C.) | (%) | (Ω · cm²) |
| Example 1 | 0.10 | Room | 120 | 95.8% | 11.3 |
| | | temperature | | | |
| Example 2 | 0.25 | Room | 120 | 96.4% | 11.0 |
| | | temperature | | | |
| Example 3 | 1.00 | Room | 120 | 97.7% | 11.7 |
| | | temperature | | | |
| Example 4 | 2.00 | Room | 120 | 98.1% | 12.9 |
| | | temperature | | | |
| Example 5 | 1.00 | Room | 160 | 99.1% | 11.8 |
| | | temperature | | | |
| Example 6 | 1.00 | Room | 200 | 96.7% | 12.0 |
| | | temperature | | | |
| Example 7 | 0.25 | 160 | 160 | 96.0% | 11.5 |
| Example 8 | 1.00 | 160 | 160 | 97.3% | 11.7 |
| Comparative | 0.00 | Room | 120 | 94.6% | 11.8 |
| Example 1 | | temperature | | | |
| Comparative | 0.00 | 160 | 160 | 94.8% | 12.0 |
| Example 2 | | | | | |

From the results in Table 1, it was confirmed that the electrode for a lithium ion secondary battery of each of the examples had a higher density retention rate of the electrode material mixture than the electrode for a lithium ion secondary battery of each of the comparative examples, and a decrease in density of the electrode active material of the electrode could be prevented.

What is claimed is:

1. An electrode for a lithium ion secondary battery, the electrode comprising:
an electrode active material;
a dendritic polymer; and
a binder,
the dendritic polymer being chemically bonded to a surface of the electrode active material, and
the dendritic polymer and the binder being chemically bonded to each other.

2. The electrode for a lithium ion secondary battery according to claim 1,
wherein the electrode active material is a negative electrode active material, and
wherein a density of a negative electrode material mixture layer comprising the electrode active material, the dendritic polymer, and the binder after impregnation with an electrolytic solution is 95% or more of a density of the negative electrode material mixture layer before impregnation with the electrolytic solution.

3. The electrode for a lithium ion secondary battery according to claim 1,
wherein the electrode active material is a negative electrode active material, and
wherein an amount of the dendritic polymer chemically bonded to the surface of the negative electrode active material is 0.1 to 1.0 part by mass with respect to 100 parts by mass of the negative electrode active material.

4. A method of manufacturing an electrode for a lithium ion secondary battery, the method comprising:
an electrode material mixture layer forming step of forming an electrode material mixture layer comprising an electrode active material, a dendritic polymer, and a binder on a current collector;
a pressing step of pressurizing at a first temperature the current collector on which the electrode material mixture layer is formed to form an electrode; and
a vacuum drying step of vacuum drying at a second temperature the electrode formed by the pressing step.

5. The method of manufacturing an electrode for a lithium ion secondary battery according to claim 4, wherein a density of the electrode material mixture layer after impregnation with an electrolytic solution is adjusted to 95% or more of a density of the electrode material mixture layer before impregnation with the electrolytic solution by adjusting the first temperature and the second temperature.
